(19) United States
(12) Patent Application Publication
(10) Pub. No.: US 2006/0074992 A1
(43) Pub. Date: Apr. 6, 2006

(54) Method and apparatus for storing image files of mobile communication terminal

(75) Inventors: Jun-Hyung Kim, Seoul (KR); Seok-Woo Jung, Incheon (KR); Bum-Jea Shin, Gyeonggi-do (KR); Byung-Chun Lim, Seoul (KR); Jae-Moon Hwang, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/239,240

(22) Filed: Sep. 30, 2005

(30) Foreign Application Priority Data
Oct. 2, 2004 (KR) 10-2004-0078533

(51) Int. Cl. G06F 17/30

(52) U.S. Cl. 707/200

(57) ABSTRACT

A method for storing an image file of a mobile communication terminal, which includes naming an image file based on at least one preset option presented to a user, and storing the named image file in a user-selected location in a memory of the mobile terminal.

### CROSS-REFERENCE TO A RELATED APPLICATION

This application claims priority to Korean Patent Application No. 10-2004-0078533, filed in Korea on Oct. 2, 2004, the entire contents of which is hereby incorporated in its entirety.

### BACKGROUND OF THE INVENTION

1. Field of the Invention

The present invention relates to a mobile communication terminal, and more particularly, to a method that allows a user of the terminal to selectively decide on names and storage locations for captured image files.

2. Description of the Related Art

In general, a mobile communication terminal is designed to allow a user to place wireless calls to another party and provide a wireless connection anytime and anywhere using a switching control of an MSC (Mobile Switching Center) while moving in a service region formed by a BS (Base Station). Thus, data communication using symbols, numbers, characters, etc, and multimedia communication including images and videos as well as voice communications can be performed. Currently, research is ongoing to develop mobile communication terminals that have a camera function and a large display device.

Further, the mobile terminal provides not only a communication function but also various additional functions that improve the user's convenience and also improves the usefulness of communication. In particular, the camera function provided with the mobile terminal is a particularly popular feature among users.

In addition, after capturing an object using the camera function, the mobile terminal automatically names the corresponding image file using a date and a number. In more detail, the mobile terminal automatically assigns a name to the image file such as ‘05420_{—}001’. Here, ‘050420’ indicates a date the picture was captured (i.e., Apr. 20, 2005), and ‘001’ is a serial number. The serial number of each image file is incremented by one.

However, the above-noted automatic naming convention is disadvantageous because the user cannot determine the relevancy or purpose of the captured image based on the name assigned by the terminal. Further, because the terminal stores the named image file in only one storage location, the user can not categorize the generated image file(s) as he or she desires.

### BRIEF DESCRIPTION OF THE INVENTION

Accordingly, one object of the present invention to at least address the above-noted and other problems.

Another object of the present invention is to provide a novel method that efficiently categorizes and stores a captured image file by naming the image file based on one or more preset user-selected options and storing the named image file in a storage location selected by a user.

To achieve these and other advantages and in accordance with the purpose of the present invention, as embodied and broadly described herein, the present invention provides a novel method for storing an image file of a mobile communication terminal, which includes naming an image file based on at least one preset option presented to a user, and storing the named image file in a memory of the mobile terminal.

The present invention also provides a novel method for storing an image file of a mobile communication terminal, which includes displaying, on a display of the mobile terminal, a name of the image file that was named based on at least one user-selected preset option, determining whether the name of an image file is to be changed, changing the name of the image file based on user- input information when the determining step determines the name of the image file is to be changed, and storing the image file in a memory of the mobile terminal with the changed name. A corresponding mobile terminal is also provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a flowchart illustrating an exemplary method for storing an image file of a mobile communication terminal according to the present invention;

FIG. 2 is a flowchart illustrating an exemplary method for modifying a name of an image file;

FIG. 3 is a flowchart illustrating an exemplary method for determining a storage location for an image file; and

FIG. 4 is an overview of a mobile communication terminal according to the present invention.

### DETAILED DESCRIPTION OF THE INVENTION

Reference will now be made in detail to the preferred embodiments of the present invention, examples of which are illustrated in the accompanying drawings.

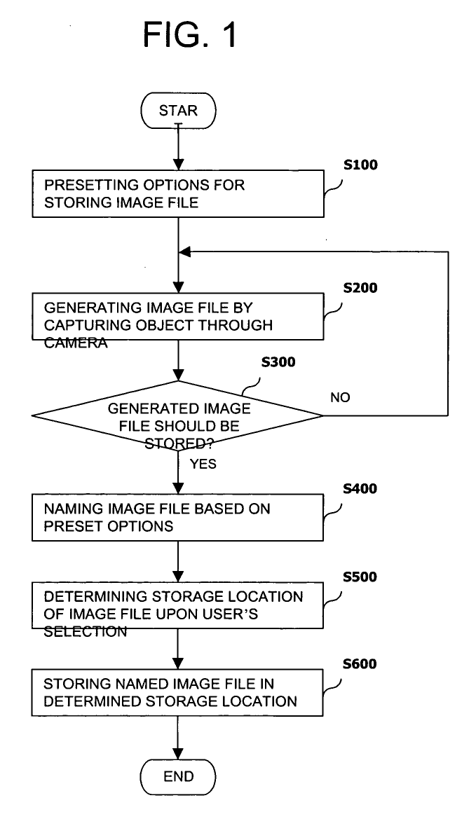

FIG. 1 is a flowchart illustrating an exemplary method for storing an image file of the mobile terminal according to the present invention. As shown, the method includes presetting options for storing image files (S100), generating an image file by capturing an object using a camera function of the terminal (S200), and determining whether the generated image file should be stored (S300). The method also includes naming the image file based on the preset options when the generated image file is to be stored (S400), determining a storage location for storing the named image file based on input from the user (S500), and storing the named image file in the determined storage location (S600). Here, if it is determined that the generated image file does not need to be stored (No in S300), the generated image file can be deleted.

Regarding the feature of presetting options for storing the image files (S100), the mobile terminal is configured to provide the user with the presetting options via a display, for example, of the mobile terminal. In more detail, the mobile terminal provides the user with one or more preset options for naming the image file. The preset options can also include a preset storage location for storing the image file as a default.

For example, the mobile terminal may provide the following preset options to the user: 1) theme, 2) date, 3) day, 4) size, and 5) number and use this information to assign a name to the captured image. Other options may also be provided. Thus, the user can then select one or more of the displayed options to selectively decide on how the captured image is to be named.

In the above example, if the user selects the options 1) theme, 2) date, and 5) number, the mobile terminal assigns a name to the image file such as ‘SEA_{—}050420_{—}001’. Note, the theme option may include predetermined options such as “Sport pics” etc. or may include text directly input by the user. In this example, the user directly input the characters “SEA” for the theme option.

After the user selects the desired preset options, the user captures the image using the camera function, and the terminal stores the captured image in the desired location selected by the user. Alternatively, the image may be captured first and then given a specific user-defined name. Further, prior to storing the image file, the terminal displays the assigned name of the image file, which has been determined based on the user-selected options.

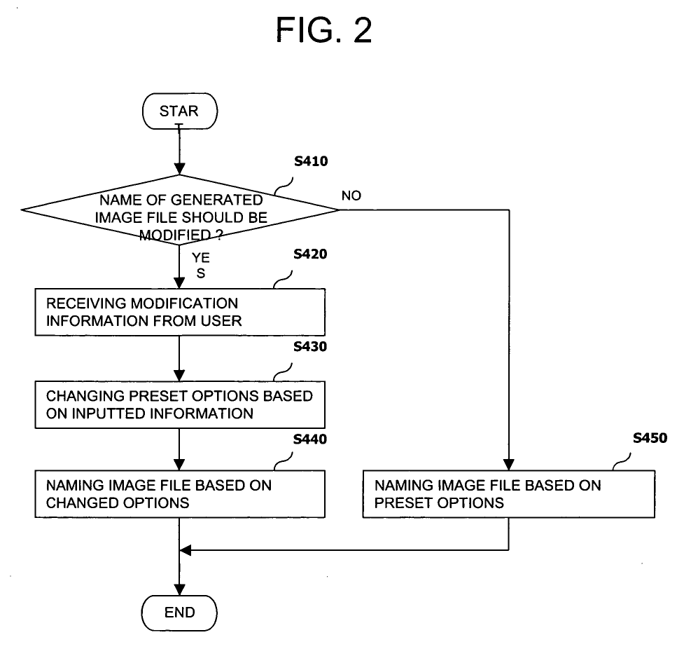

Turning next to FIG. 2, which is a flowchart illustrating an exemplary method for changing the name of an image file according to the present invention. As shown, the method includes determining whether the displayed name of the image file should be modified or changed (S410), receiving modification information from the user when the image file is to be modified (420), modifying the information corresponding to the selected preset option(s) based on the inputted information (S430), and naming the image file based on the information input by the user (S440). Here, if the name of the generated image file does not need to be modified (No in S410), the terminal uses the originally assigned name, which was generated based on the user-selected preset options (S450).

In more detail, the mobile terminal displays the name of the image file generated based on the user-selected preset options to provide the user with the option of changing the image file name. As noted above, if the user does not want to change the displayed image file name, the mobile terminal assigns the originally-displayed name to the generated image file. However, if the user indicates he or she wants to change the name of the displayed image file, the user can directly modify the displayed name of the image file. For example, if the displayed image file name is ‘SEA_{—}050420_{—}001,’ the user can directly modify the ‘SEA’ part into ‘SKY’ via input keys provided on the terminal. Further, when the terminal recognizes the theme of the image file has been changed, the appropriate information corresponding to the preset option is thereby modified. In this instance, the terminal appropriately modifies and stores the image file with the name ‘SKY_{—}050420_{—}001.’

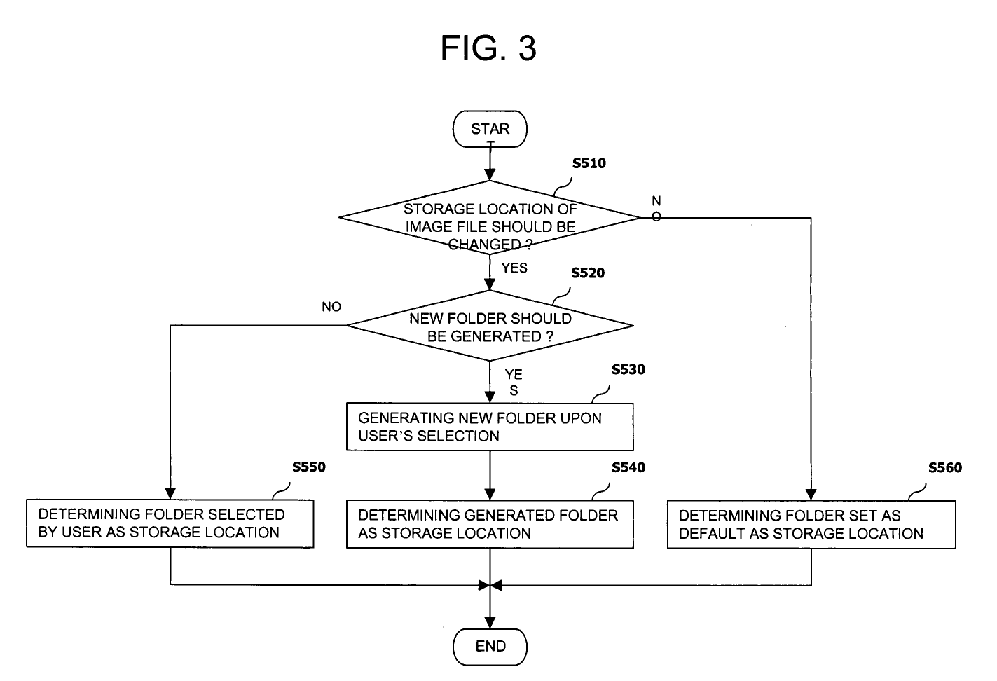

In addition, the mobile terminal determines a storage location for storing the named image file based on information provided by the user. The method for determining the storage location of the named image file will now be described with reference to the flowchart of FIG. 3.

As shown, the method includes determining whether a storage location of the named image file should be changed (S510), determining whether a new folder needs to be generated when the storage location of the image file is to be changed (S520), generating a new folder based on the user's selection if the new folder needs to be generated (S530), and determining the generated folder as a storage location of the image file (S540).

Here, if the storage location of the named image file is not to be changed (No in S510), the terminal determines a folder, which has been set as the default, as the storage location (S560). If the new folder does not to be generated (No in S520), a folder selected from existing folders is determined as the storage location (S550).

In more detail, the terminal first determines whether or not the user wants to change the storage location (e.g., folder) for the captured image file. If the storage location of the image file is not to be changed, the terminal uses a default folder as the storage location for the captured image file. However, if the user selects a particular folder different than the default folder, the terminal determines whether the user-selected folder already exists or whether a new folder needs to be generated.

If the user-selected folder already exists, the terminal stores the captured image file in the existing user-selected folder. However, if the user- selected folder does not exist, the terminal generates a new folder corresponding to the user-selected folder. The terminal then stores the captured image file in the newly generated folder.

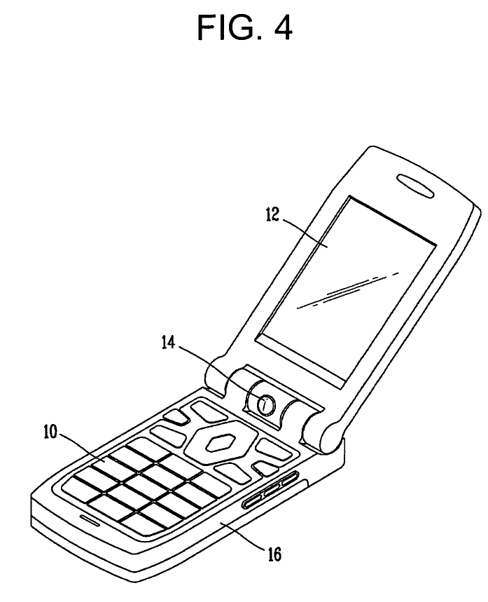

Turning next to FIG. 4, which illustrates a mobile communication terminal according to the present invention. The terminal performs the functions discussed above with respect to FIGS. 1-3. As shown in FIG. 4, the terminal includes a keypad 10, a display 12, a camera 14 and a Printed Circuit Board (PCB) 16. The PCB includes a variety of circuitry used to operate the terminal including a central processing unit (CPU) and appropriate memories. The mobile terminal performs at least the functions of displaying preset naming options to the user on the display 12, and generating and storing a captured image file based on information input by the user. The user can input information into the terminal via the keypad 10.

Further, the terminal displays the name of the captured image file on the display 12, and allows the user to modify or change the name using the keypad 10. The terminal also presents options to the user on the display 12 allowing the user to selectively determine where the captured image file is stored. The terminal also performs the other noted functions discussed above with respect to the flowcharts in FIGS. 1-3.

In addition, the image data includes, for example, photographs, video clips or other image capture formats. The options presented to the user may also include different types of descriptive information that are selectable for each type of image data to be stored as an image file. The selected name or label can be automatically attached to the image file, or the user may modify a particular recommended name or label and the modified name or label is then attached to the image file. Also, image files having a common label or common descriptive information can be stored together within one or more separate folders of the memory to hierarchical store the files.

Thus, the image file storing method of the present invention is advantageous at least because the captured image can be efficiently categorized and stored based on information input by the user. Therefore, an additional flexibility is provided to the communication terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for storing an image file of a mobile communication terminal, the method comprising:
naming an image file based on at least one preset option presented to a user; and
storing the named image file in a memory of the mobile terminal.

2. The method of claim 1, further comprising:
determining if the image file is to be stored in a user-selected storage location of the memory,
wherein the storing step stores the image file in the user-selected storage location if the determining step determines the image file is to be stored in the user-selected storage location.

3. The method of claim 2, wherein if the determining step determines the image file is not to be stored in the user-selected storage location, the storing step stores the named image file in a default storage location of the memory.

4. The method of claim 1, wherein the at least one preset option comprises at least one of a theme, a date, a day, a size and/or a number of the image file.

5. The method of claim 4, wherein the number of the image file is a consecutive serial number assigned to image file named according to the theme option.

6. The method of claim 1, wherein the image file is a video image file or a still image file.

7. A method for storing an image file of a mobile communication terminal, the method comprising:
displaying, on a display of the mobile terminal, a name of the image file that was named based on at least one user-selected preset option;
determining whether the name of an image file is to be changed;
changing the name of the image file based on user-input information when the determining step determines the name of the image file is to be changed; and
storing the image file in a memory of the mobile terminal with the changed name.

8. The method of claim 7, wherein the at least one user-selected preset option comprises at least one of a theme, a date, a day, a size and/or a number of the image file.

9. The method of claim 8, wherein the number of the image files is a consecutive serial number consecutively assigned to image files named according to the theme option.

10. The method of claim 7, wherein the image file is a moving image file or a still image file.

11. The method of claim 7, wherein changing the name of the image file comprises:
receiving modification information corresponding to the displayed name from the user when the name of the image file is to be changed; and
changing information corresponding to the at least preset option based on the received modification information,
wherein changing the name changes the name of the image file based on the information corresponding to the at least one changed preset option.

12. The method of claim 7, further comprising:
assigning the image file the name displayed on the display if the determining step determines the name is not to be changed.

13. The method of claim 7, wherein storing the image file comprises:
determining if the image file is to be stored in a user-selected folder in the memory,
wherein the storing step stores the image file in the user-selected folder if the determining step determines the image file is to be stored in the user-selected folder.

14. The method of claim 13, wherein the storing step stores the image file in a default storage location if the determining step determines the image file is not to be stored in the user-selected folder.

15. The method of claim 13, wherein determining if the image file is to be stored in the user-selected folder comprises:
determining whether a new folder needs to be generated or whether the user-selected folder already exists; and
generating the new folder when it is determined the new folder needs to be generated,
wherein the storing step stores the image file in the new generated folder.

16. The method of claim 15, wherein the storing step stores the image file in the existing user-selected folder if the user-selected folder already exists.

17. A mobile communication terminal comprising:
a camera configured to capture an image as an image file;
a display configured to display at least one preset option selected by a user for naming the captured image file;
a processor configured to name the captured image file based on the at least one preset option selected by the user; and
a memory configured to store the named image file.

18. The terminal of claim 17, wherein the display displays storage options allowing the user to select a user-specified folder to store the named image file.

19. The terminal of claim 18, wherein the processor determines if the user wants to store the image file in the user-specified folder, stores the image file in the user-specified folder when it is determined the user wants to store the image file in the user-selected folder, and stores the image file in a default storage area in the memory when it is determined the user does not want to store the image file in the user-selected folder.

20. The terminal of claim 19, wherein the processor determines whether a new folder needs to be generated or whether the user-specified folder already exists, generates the new folder when it is determined the new folder needs to be generated, and stores the image file in the new generated folder or the existing user-specified folder if it exists.

21. The terminal of claim 17, wherein the at least one preset option comprises at least one of a theme, a date, a day, a size and/or a number of the image file.

22. The terminal of claim 21, wherein the number of the image file is a consecutive serial number assigned to image file named according to the theme option.

23. The terminal of claim 17, wherein the image file is a video image file or a still image file.

24. The terminal of claim 17, wherein the display displays the name of the image file that was named based on at least one user-selected preset option, and wherein the processor determines whether the name of the image file is to be changed, changes the name of the image file based on user-input information when the processor determines the name of the image file is to be changed, and stores the image file in the memory of the mobile terminal with the changed name.
